(19) United States
(12) Patent Application Publication
(10) Pub. No.: US 2009/0166282 A1
(43) Pub. Date: Jul. 2, 2009

(54) PHOTOCATALYSED OXIDATION PURIFICATION DEVICE

(75) Inventor: Yubo Dong, Beijing (CN)

Correspondence Address: YING CHEN;Chen Yoshimura LLP, 255 S. GRAND AVE., # 215, LOS ANGELES, CA, 90012, US

(73) Assignee: Beijing Jinaohuarong Science and Technology Co., Ltd., Beijing (CN)

(21) Appl. No.: 12/110,495

(22) Filed: Apr. 28, 2008

(30) Foreign Application Priority Data
Dec. 28, 2007 (CN) 200710304543.2

(51) Int. Cl. B01J 8/42; C02F 1/32; C02F 1/72

(52) U.S. Cl. 210/251; 210/291; 210/198.1; 210/748

(57) ABSTRACT

This invention relates to a photocatalysed oxidation purification device, comprising middle part, upper part and lower part which are divided by two transverse clapboards, wherein the upper clapboard is micropore plate and the lower clapboard is macropore plate, the middle part of said device is a fluidized bed chamber, the lower part of said device is a mixing chamber and the upper part of said device is a current regulating chamber, several ultraviolet lamps are placed in the said fluidized bed chamber with particles photocatalyst inside, the inlet pipe of said device is connected to the said mixing chamber and its running direction is oblique or tangential, the outlet pipe of said device is connected to the current regulating chamber and its running direction is radial. There is also an ozonizer on the device. This device possesses a higher purifying degree, a larger processing capacity and a relatively lower processing cost, which is suitable for locations requiring higher purified water.

### BACKGROUND OF THE INVENTION

1. Field of the Invention

This invention relates to a photocatalysed oxidation purification device used mainly to purify water.

2. Description of the Related Art

Photocatalysed oxidation is a water treatment technique of higher purifying degree, which is able to oxidize most organic pollutants such as alkane, aliphatic alcohol, aliphatic acid, hydroxybenzene, organic acid, dyes, surface active agent, pesticides and etc. When the requirements of water purifying are higher and the pollution of water supply reaches certain level, a filtering and aerobic biochemical treatment is not enough to meet the purifying requirements. People often turn to membrane filtration and etc as an advanced purifying treatment under such circumstance. But such treatments are restricted in large-scale water treatments because of the relatively lower processing capacity and higher cost.

On the other hand, the problem of low concentrated organic pollution in water is becoming more and more serious. There is a trait of organic materials as well as various poisonous or noxious synthetic compounds, byproducts of disinfecting water sources and trace amount of hazardous materials in drinking water.

### SUMMARY OF THE INVENTION

To overcome above disadvantage of exited techniques, this invention offers a device of water purifying treatment with photocatalysed oxidation as main method. Said device have a higher processing capacity and can reach a higher purifying degree with a relatively lower processing cost.

To achieve above purpose, the technical solution of the present invention is that: a photocatalysed oxidation purification device, comprising middle part, upper part and lower part which are divided by two transverse clapboards, wherein the upper clapboard is micropore plate and the lower clapboard is macropore plate, the middle part of said device is a fluidized bed chamber, the lower part of said device is a mixing chamber and the upper part of said device is a current regulating chamber, several ultraviolet lamps are placed in the said fluidized bed chamber with particles photocatalyst inside, the inlet pipe of said device is connected to the said mixing chamber and its running direction is oblique or tangential, the outlet pipe of said device is connected to the current regulating chamber and its running direction is radial.

The working process of this device is that: water enters the device from its bottom, forms a rotational flow, mixes with the ozone from the ozonizer intensively in the mixing chamber, then flows into the fluidized bed chamber through the pores on lower clapboard and pushes the photocatalyst particles with upthrust to make them in a suspended state. The lower clapboard adopts macropore plate in order that the water flow in the fluidized bed chamber can form some up and down volution to strengthen the mixing effects and to improve oxidation reaction speed. The ultraviolet lamps are shining over the photocatalyst particles constantly to keep them active while the photocatalyst particles in the fluidized bed are moving up and down all the time in order that all particles can receive ultraviolet light to put into full play. The upper clapboard adopts micropore plate and water flow will be steady after the rotational flow vanishes evenly, meanwhile the fine photocatalyst particles brought will be settled naturally.

The main action mechanism of this device is that: during the process of the photocatalysed oxidation of ozone, the pollutants in water turn into carbon dioxide and water under the effect of various degradations/decompositions, comprising catalytic oxidation, ozone oxidation, ozone/ultraviolet oxidation and so on. Adding ozone in the process of the photocatalysed oxidation can greatly increase the speed of decomposing organic pollutants, thus greatly reduce the catalytic time as well as photocatalysed cost; meanwhile under the effect of ultraviolet light and photocatalyzer, the transferring of ozone in water will be fastened, the operating factor will be improved, the ozone content will be decreased in the trail gas to reduce harm and the organic pollutants will be decomposed or removed more.

The advantageous effects of the invention is: simple structure, reasonable water current, better mixing effect, highly active photocatalyzer, favor for improving reaction speed and effect as well as purifying degree. In addition, because small scale of ozone is added in the process of the photocatalysed oxidation, under the effect of ultraviolet light and photocatalyzer, the operating factor is improved, thus the removing speed of organic matter is greatly improved, the processing time is greatly shortened and the processing cost is greatly reduced, especially for those organic matters after the former biological treatment. Adopting this effective method of adding ozone with catalyzer, those organic matters possess low opportunity of being with biochemistry property.

### BRIEF DESCRIPTION OF THE DRAWING

FIG. 1 is the structural scheme of this invention.

### DETAILED DESCRIPTION OF THE PREFERRED EMBODIMENTS

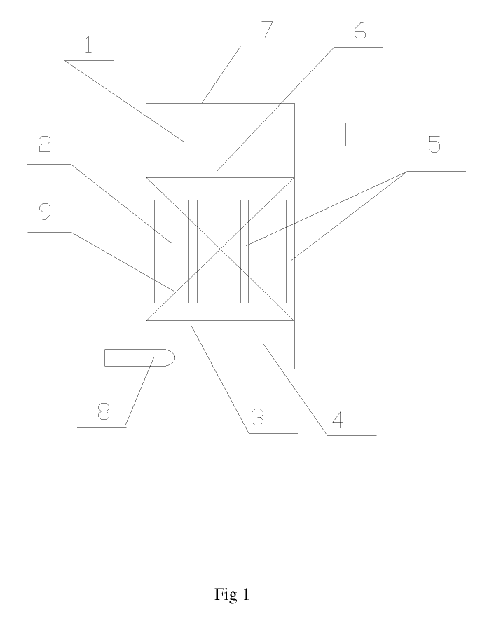

As shown in FIG. 1, this invention offers a photocatalysed oxidation purification device, comprising middle part, upper part and lower part which are divided by two transverse clapboards 6, 3, wherein the two clapboards are all pore plates while the upper one is microspore plate and the lower one is macrospore, the middle part inside the said device is a fluidized bed chamber 2, the lower part is a mixing chamber 4 and the upper part is a current regulating chamber 1, there are several vertical ultraviolet lamps 5 in the said fluidized bed chamber with photo catalyst particles 9 inside and there is photo catalyst all over the surface of the said particles, the inlet pipe 8 of said device is connected to the said mixing chamber and its running direction is oblique or tangential, the outlet pipe of said device is connected to the current regulating chamber and its running direction is radial.

There is also an ozonizer on the device, which can be installed separately or shares the same pipe with the said inlet pipe. This device possesses a higher purifying degree, a larger processing capacity and a relatively lower processing cost, which is suitable for locations requiring higher purified water.

Generally, the body of purifying device 7 and the clapboards all adopt metal structure or other materials according actual needs, e.g. glass fiber reinforced plastic.

The said purifying device generally adopts round device (with round section) which is favor of avoiding dead angles.

The upper clapboard generally adopts micropore plate to realize the purpose of pressure equalizing and steady current.

The upper clapboard generally adopts macropore plate in favor of uneven water flow all over the board within certain range above the clapboard to form up and down opposite volutions, which are good for improving the effects of fluidized bed and constant movement of the particles to receive the shining ultraviolet lights.

The ultraviolet lamps are generally running up and down and better to be installed on inside wall to form protection, reduce outside wall abrasion as well as realize airproof.

The said ultraviolet lamp tubes can be covered with silica tubes outside for protection.

The said ozonizer can be set separately or share the same pipe with the said inlet pipe, that is, two inlets will be set on the same pipe, one for water and the other for ozone.

According to the outlet manner of the ozonizer, the said ozone can be both air or dissolved in water. The said ozonizer is connected to the ozone outlet pipe of the ozonizer or water outlet pipe containing dissolved ozone.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A photocatalysed oxidation purification device, comprising:
a fluidized bed chamber in a middle part of the device;
a current regulating chamber in an upper part of the device,
a mixing chamber in a lower part of the device,
an upper transverse clapboard dividing the upper part and the middle part, the upper clapboard being a micropore plate;
a lower transverse clapboard dividing the middle part and the lower part, the lower clapboard being a macropore plate;
a plurality of ultraviolet lamps located in the fluidized bed chamber with particles photocatalyst inside,
an inlet pipe connected to the mixing chamber, a running direction of the inlet pipe being oblique or tangential; and
an outlet pipe connected to the current regulating chamber, a running direction of the outlet pipe being radial.

2. The device of claim 1, further comprising an ozonizer, wherein said ozonizer is installed separately or shares a same pipe with said inlet pipe of said device.

3. The device of claim 2, wherein said ozonizer has an ozone outlet pipe.

4. The device of claim 2, wherein said ozonizer has an outlet pipe of water containing dissolved ozone.

5. The device of claim 1, wherein a shell of said device is round.

6. The device of claim 5, wherein said ultraviolet lamps are vertically placed.

7. The device of claim 6, wherein said ultraviolet lamps are installed on an inside of the shell of said device.

8. The device of claim 7, wherein tubes of the ultraviolet lamps are covered with silica tubes outside.

9. The device of claim 2, wherein a shell of said device is round.

10. The device of claim 9, wherein said ultraviolet lamps are vertically placed.

11. The device of claim 10, wherein said ultraviolet lamps are installed on an inside of the shell of said device.

12. The device of claim 11, wherein tubes of the ultraviolet lamps are covered with silica tubes outside.

13. The device of claim 3, wherein a shell of said device is round.

14. The device of claim 13, wherein said ultraviolet lamps are vertically placed.

15. The device of claim 14, wherein said ultraviolet lamps are installed on an inside of the shell of said device.

16. The device of claim 15, wherein tubes of the ultraviolet lamps are covered with silica tubes outside.

17. The device of claim 4, wherein a shell of said device is round.

18. The device of claim 17, wherein said ultraviolet lamps are vertically placed.

19. The device of claim 18, wherein said ultraviolet lamps are installed on an inside of the shell of said device.

20. The device of claim 19, wherein tubes of the ultraviolet lamps are covered with silica tubes outside.
